(19) United States
(12) Patent Application Publication
(10) Pub. No.: US 2013/0112090 A1
(43) Pub. Date: May 9, 2013

(54) SHELL-LESS EGG-BOILING UTENSIL

(71) Applicant: Xavier Costa, Barcelona (ES)

(72) Inventor: Xavier Costa, Barcelona (ES)

(73) Assignee: LEKUE, S.L., Barcelona (ES)

(21) Appl. No.: 13/460,688

(22) Filed: Apr. 30, 2012

(30) Foreign Application Priority Data
May 3, 2011 (ES) U201100404

(51) Int. Cl. A47J 29/06

(52) U.S. Cl. CPC A47J 29/06
USPC 99/440

(57) ABSTRACT

The utensil comprises a flexible container (10), sized to contain at least one shell-less egg, and a lid (20) capable of closing said container (10), wherein the container (10) containing said shell-less egg and closed by said lid (20) can float in boiling water in order to boil the egg. The container (10) comprises a cup (11) having an upper region (11a) adjacent to a top opening (13) that is bulkier than a lower region (11b) adjacent to a bottom (12). The container (10) has a perimetric flap (14) extending outwards and downwards from a rim of the top opening (13), so that, when the utensil is floating, said perimetric flap (14) traps air, thereby contributing to the buoyancy and flotation stability of the utensil, with the cup (11) being substantially submerged and the lid (20) being substantially above water.

### FIELD OF THE ART

The present invention relates in general to a shell-less egg-boiling utensil and, more in particular, to a flexible container having a lid sized to receive one or more shell-less eggs and capable of floating, when it is full and covered by said lid, in boiling water.

### BACKGROUND OF THE INVENTION

It is known how to prepare boiled eggs in their shell immersing the whole eggs in boiling water for a pre-established time. However, this simple process has some drawbacks. On the one hand, there is the risk that the eggshell will crack or break due to temperature changes and impacts produced by turbulence in the boiling water, resulting in the egg white coming out of the shell and dispersing in the boiling water. On the other hand, boiling an egg in its shell does not allow for the addition of seasoning or other foods that can be combined with the egg while it is being boiled. In addition, boiled eggs in their shell must be manually peeled once they are boiled, which entails a cumbersome, not much hygienic operation.

ES-0159276-U describes a kitchen utensil that allows for the boiling of shell-less eggs. This kitchen utensil comprises a rigid container for containing a shell-less egg, a lid for hermetically sealing the container and a support having legs and a handle for supporting and handling the container. Said support can be held by the handle and handled to submerge the container, closed with its lid and containing a shell-less egg, in the boiling water contained in a pan. The support legs can rest on the bottom of the pan, keeping the base of the container away from the bottom of the pan during boiling. One drawback of this kitchen utensil is that the assembly of the container and the support is bulky, cumbersome to handle and difficult to put away, and the rigid container is fragile and hardly practical if one wishes to demould the egg once it is boiled.

JP-1281059-A describes a container having a bottom and a top opening, and a lid closing said top opening. The container is sized to contain a shell-less egg and has a lower region adjacent to the bottom narrower than an upper region adjacent to the opening. The container containing a shell-less egg and closed by means of the lid is caused to float in hot water contained in a pan and the water is heated in a microwave oven so as to boil the egg. One drawback of this container is that the upper region adjacent to the opening needs to be very wide in comparison with the lower region in order to ensure flotation stability. Another drawback is that, for removing the container, one has to immerse their fingers in the boiling water, since it has no handle whatsoever.

US-2010/0224081-A1 discloses a flexible floating container for boiling shell-less eggs that comprises a flexible body in the shape of a cup configured and sized to float in boiling water without tipping or spilling a shell-less egg contained therein. One drawback of this container is that it does not have a lid, so that spattering of boiling water can be deposited on the egg.

### DISCLOSURE OF THE INVENTION

The present invention contributes to the mitigate the above and other drawbacks by providing a utensil for boiling shell-less eggs of the type comprising a container, sized to contain at least one shell-less egg, and a lid capable of hermetically closing said container, wherein the container containing said shell-less egg and closed by said lid can be immersed at least partially in boiling water in order to boil the egg. The container comprises a cup with a bottom, a top opening and a perimetric closing element arranged around said top opening, and the lid comprises a cover wall and a perimetric closing element that press fits into said perimetric closing element of the container, wherein said cup of the container has an upper region adjacent to the top opening that is bulkier than a lower region adjacent to said bottom, so that the container, closed with the lid and containing said shell-less egg, will float in the boiling water with the cup being substantially submerged and the lid being substantially above water.

The utensil of the present invention is characterised in that the container is made of a flexible material, such as platinum-catalysed silicone, and has a perimetric flap extending outwards and downwards from a rim of the top opening thereof. When the utensil is floating, this perimetric flap tends to trap air, thereby contributing to the buoyancy and flotation stability of the utensil in an upright position, with the top opening closed by the lid on the upper side.

The bulkier upper region and the perimetric flap ensure enough buoyancy to keep the lid substantially out of the water. The shell-less egg is located by gravity in said lower region adjacent to the bottom of the container, and this causes the centre of gravity of the floating utensil to remain well below water level, which, in combination with the effect of the perimetric flap, contributes to said flotation stability.

The lid is also preferably made of a flexible material, such as platinum-catalysed silicone, and comprises a handle attached to said cover wall in such a position that said handle is substantially above water when the utensil is floating in boiling water. The perimetric closing element of the container and the perimetric closing element of the lid are configured so that, when press fitted together, they provide enough frictional force to lift the container containing said shell-less egg together with the lid when the utensil is grabbed by the handle. That way, a user can grab the handle without the risk of scalding their fingers for removing the utensil from the boiling water.

In an embodiment, the perimetric closing element of the container comprises an inner conical surface formed in said upper region of the cup and the perimetric closing element of the lid comprises an outer conical surface formed in a perimetric skirt extending downwards from the cover wall. The degree of conicity of these inner and outer conical surfaces is very low in order to ensure said frictional force capable of keeping the container attached to the lid. However, due to the flexible nature of the container and, eventually, of the lid, the lid can be easily removed through the deformation of the closing elements.

In one particular embodiment, the cover wall of the lid has the shape of a convex dome and it has a concave depression in its top central area. In this case, the handle has the shape of a knob located in said concave depression and, preferably, it does not protrude therefrom. This contributes to keeping the centre of gravity in a low position, necessary for the flotation stability of the device. Preferably, the perimetric flap of the container has a convex shape, but it can be supplemental of said dome shape of the cover wall of the lid so as to provide more room to the gap capable of trapping air between the perimetric flap and the cup of the container.

Said upper region of the cup of the container generally has a substantially frustoconical configuration correlated with an inner frustoconical surface of the press fit closing element of the container. However, the lower region of the container can adopt numerous configurations, and the shell-less egg, once boiled, will maintain the shape of this lower region of the container.

In one embodiment, the lower region of the container has a substantially hemispherical shape connecting with the upper frustoconical region without interruption in continuity. In another embodiment, the lower region has a substantially cylindrical or frustoconical shape, but of a smaller diameter than the upper frustoconical region and, as a result, the cup of the container includes a transition region connecting the upper and lower regions thereof. In yet another embodiment, the lower region of the cup of the container has a substantially prismatic or frustopyramidal shape, and in this case the cup also includes a transition region connecting the upper and lower regions thereof.

Whatever the shape of the lower region of the cup of the container, the shell-less egg, once boiled, can be easily demoulded by turning over the container upside down and manually pressing the bottom thereof so as to deform the cup, thereby dislodging the boiled egg, which is possible thanks to the flexible nature of the container.

### BRIEF DESCRIPTION OF THE DRAWINGS

The above and other features and advantages will be more fully understood from the following detailed description of exemplary embodiments with reference to the accompanying drawings, in which:

FIGS. 1 and 2 are exploded perspective views showing the upper side and the lower side, respectively, of a container and a lid that together make up a shell-less egg-boiling utensil according to a first embodiment of the present invention;

FIG. 3 is a perspective view of the utensil of FIGS. 1 and 2 in a closed position;

FIG. 4 is a cross-sectional view taken along the plane IV-IV of FIG. 3;

FIGS. 5 and 6 are exploded perspective views showing the upper side and the lower side, respectively, of a container and a lid that together make up a shell-less egg- boiling utensil according to a second embodiment of the present invention;

FIG. 7 is a perspective view of the utensil of FIGS. 5 and 6 in a closed position;

FIG. 8 is a cross-sectional view taken along the plane VIII-VIII of FIG. 7;

FIGS. 9 and 10 are exploded perspective views showing the upper side and the lower side, respectively, of a container and a lid that together make up a shell-less egg-boiling utensil according to a third embodiment of the present invention;

FIG. 11 is a perspective view of the utensil of FIGS. 9 and 10 in a closed position; and

FIG. 12 is a cross-sectional view taken along the plane XII-XII of FIG. 11.

### DETAILED DESCRIPTION OF EMBODIMENTS

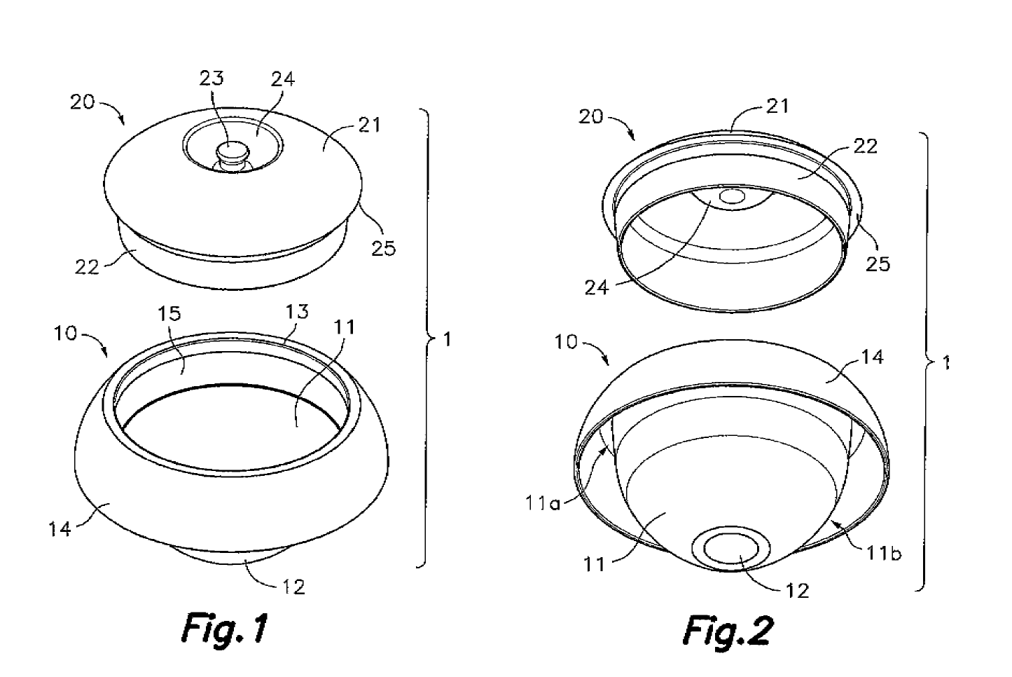

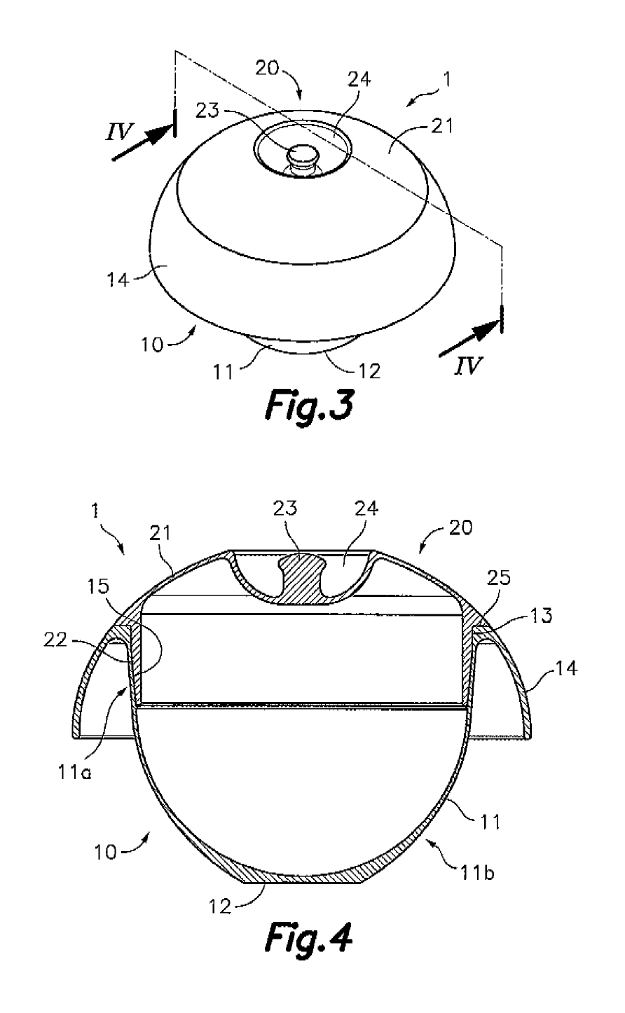

Referring first to FIGS. 1 to 4, numeric reference 1 designates generally a shell-less egg-boiling utensil according to a first embodiment of the present invention, which comprises a container 10 sized to contain one, or more than one, shell-less egg (not shown) and a lid 20 capable of closing said container 10. Both the container 10 and the lid 20 are made of a flexible material, and preferably of platinum-catalysed silicone. Alternatively, only the container might be made of a flexible material. The container 10 containing said shell-less egg and closed by said lid 20 can be submerged at least in part in boiling water so as to boil the egg.

The container 10 comprises a cup 11 having a bottom 12 and a top opening 13. The cup 11 of the container has an upper region 11a adjacent to said top opening 13 that is bulkier than a lower region 11b adjacent to said bottom 12. When the eggshell is broken and its content is poured into the container, the shell-less egg is naturally deposited by gravity in the lower region 11b of the cup 11, on the bottom 12 thereof, providing a low centre of gravity. This way, by virtue of the larger volume of the upper region 11a of the cup 11 and of the low centre of gravity, located in the lower region 11b, the container 10, closed by the lid 10 and containing said shell-less egg, floats in boiling water, with the cup 11 being substantially submerged and the lid 20 being substantially above water.

In addition, the container 10 has a perimetric flap 14 extending outwards and downwards from a rim of said top opening 13 of the cup 11. Thus, when the utensil is floating, said perimetric flap 14 tends to trap air, thereby contributing to the buoyancy and flotation stability of the utensil. Preferably, the perimetric flap 14 of the container 10 has a convex shape so as to provide more room to a gap, capable of trapping air, defined between the perimetric flap 14 and the upper region 11a of the cup 11 of the container 10.

In this first embodiment, said upper region 11a of the cup 11 has a substantially frustoconical configuration and said lower region 11b has a substantially hemispherical shape. The minimal lower diameter of the upper frustoconical region 11a is the same as the maximum upper diameter of the lower hemispherical region 11b, so that both upper and lower regions of the cup 11 are connected without interruption in continuity.

The upper region 11a of the cup 11 includes a perimetric closing element 15 in the shape of an inner conical surface formed around the top opening 13. The lid 20 comprises a cover wall 21 and a perimetric skirt extending downwards from the cover wall 21, and in this perimetric skirt a perimetric closing element 22 is formed in the shape of an outer conical surface press fitting in said lower conical surface of the perimetric closing element 15 of the container 10.

In addition, the lid 20 comprises a handle 23 attached to said cover wall 21 in such a position that said handle 23 is substantially above water when the utensil is floating in boiling water. In this first embodiment, the cover wall 21 of the lid 20 has the shape of a dome with a concave depression 24 in its top central area and the handle 23 has the shape of a knob located in said concave depression 24.

Said inner conical surface of the perimetric closing element 15 of the container 10 and said outer conical surface of the perimetric closing element 22 of the lid 20 have a very low degree of conicity, so that, when they are mutually press fitted, they provide enough frictional force to lift the container 10 containing said shell-less egg together with the lid 20 when the utensil is grabbed by the handle 23. This allows for the handling of the entire utensil 1 by grabbing it by the handle 23 and avoids immersing one's fingers in the boiling water to remove the utensil 1 from the pan containing the boiling water.

An outer rim of the cover wall 21 protrudes from the perimetric skirt wherein the perimetric closing element 22 of the lid 20 is formed and creates a tread 25 leaning on an upper rim of the cup 11 and the container 10 when the lid 20 closes the container 10 with the respective perimetric closing elements 15, 22 being press fitted. In this position, the closure is substantially airtight. The opening of the utensil is carried out with ease due to the deformable nature of the container 10 and the lid 20.

Since the egg white has a semiliquid consistency, the shell-less egg, when raw, adopts the shape of the lower region 11b of the cup 11 and maintains this shape once it is boiled, as the lower region 11b of the cup 11 acts as a mould. With the utensil 1 according to the first embodiment shown in FIGS. 1 to 4, the shell-less egg white will adopt a hemispherical configuration, with the substantially spherical yolk inside it. The boiled shell-less egg can be removed or demoulded from the utensil 1 by opening the container 10 and manually pressing the bottom 12 of the cup 11 towards the top opening 13 so as to deform the cup 11, thereby dislodging the boiled egg, which is easily feasible thanks to the flexible nature of the container 10.

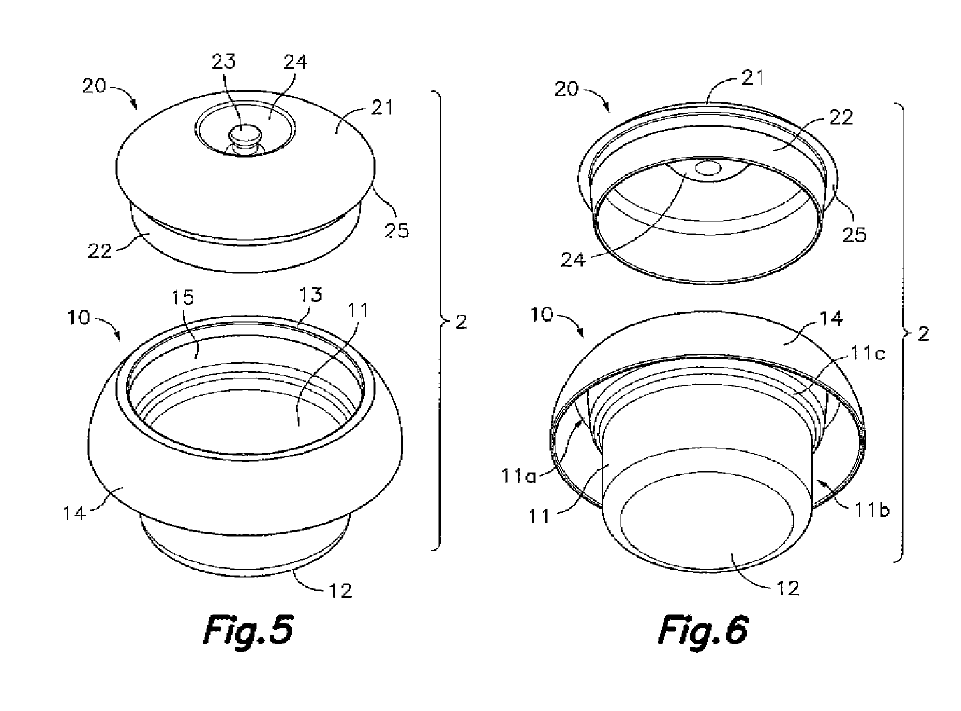

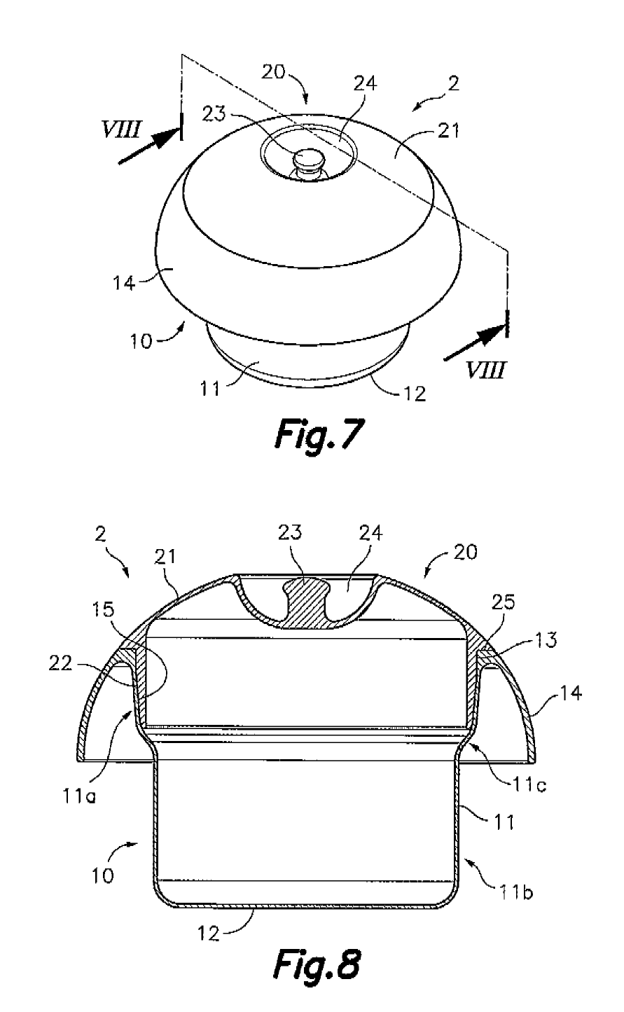

Referring now to FIGS. 5 to 8, a shell-less egg-boiling utensil 2 is described according to a second embodiment of the present invention, which is entirely identical to the utensil 1 of the first above-described embodiment related to FIGS. 1 to 4, except in the shape of the lower region 11b of the cup 11. Therefore, the description of the lid 20 and the upper region 11a of the cup 11 of the container 10 including the perimetric flap 14 will be omitted herein.

The utensil 2 of this second embodiment has a substantially frustoconical upper region 11a of the cup 11 of the container 10, the same as in the first embodiment, whereas the lower region 11b of the cup 11 has a substantially cylindrical or slightly frustoconical shape with a flat base 12. The maximum diameter in the upper end of the Lower region 11b is clearly smaller than the minimum diameter of the lower end of the upper region 11a. As a result, the cup includes a transition region 11c connecting the upper and lower regions of the cup 11.

With the utensil 2 according to the second embodiment shown in FIGS. 5 to 8, the shell-less egg white will adopt a cylindrical or slightly frustoconical configuration, the substantially spherical yolk being inside it.

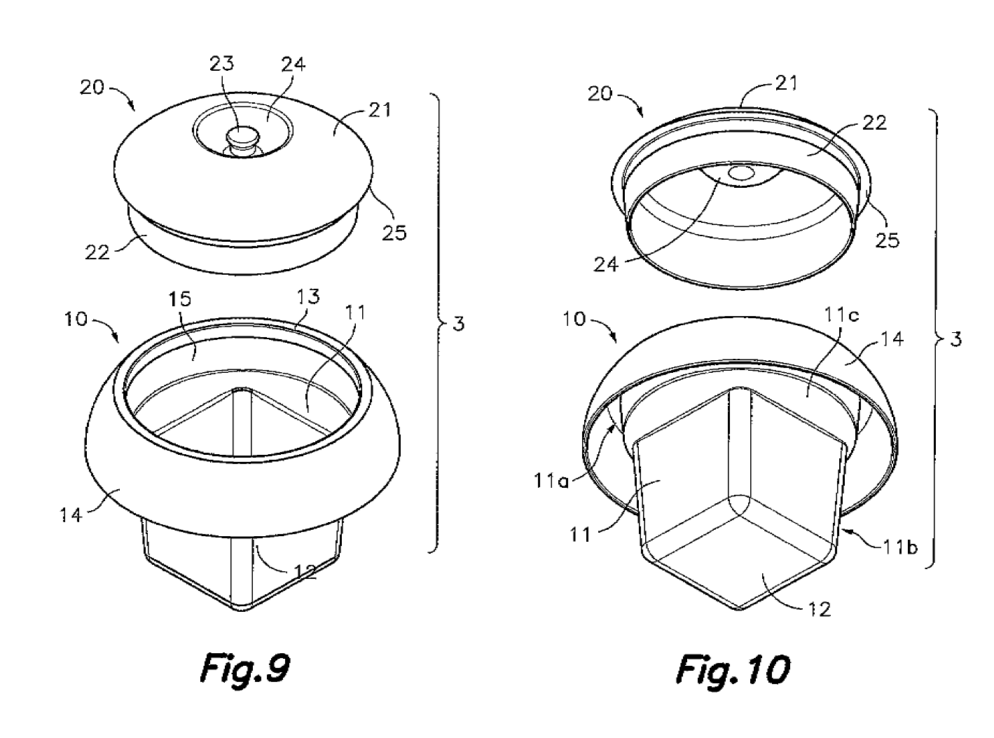

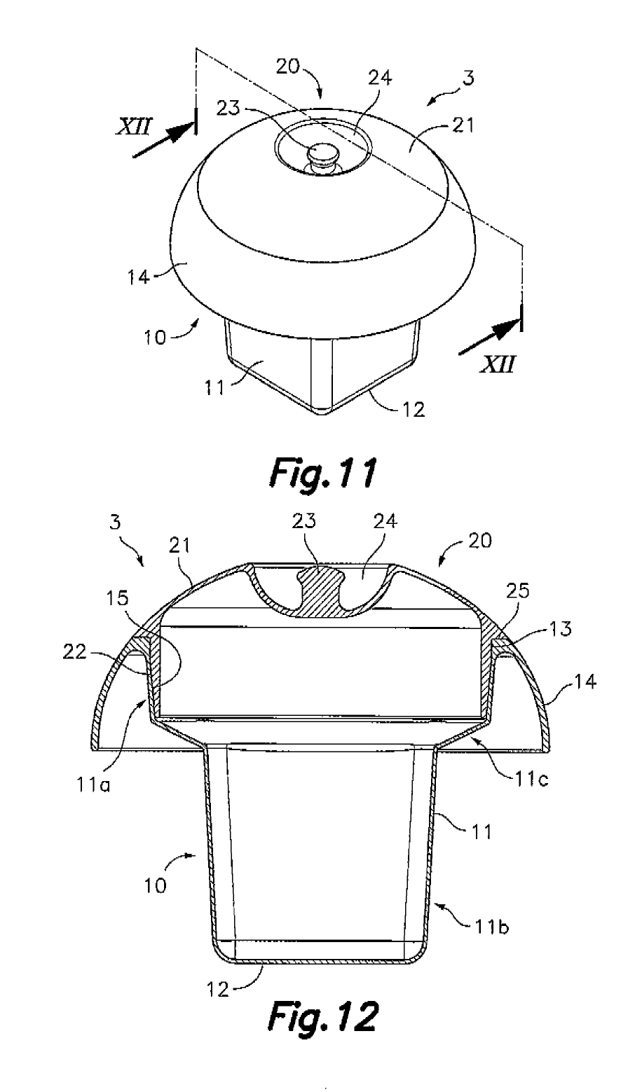

Referring now to FIGS. 9 to 12, a shell-less egg-boiling utensil 3 is described according to a third embodiment of the present invention, which is entirely identical to the utensil 1 of the first embodiment described above in relation to FIGS. 1 to 4, except in the shape of the lower region 11b of the cup 11. Therefore, the description of the lid 20 and the upper region 11a of the cup 11 of the container 10 including the perimetric flap 14 will be omitted herein.

The utensil 3 of this third embodiment has a substantially frustoconical upper region 11a of the cup 11 of the container 10, the same as in the first embodiment, whereas the lower region 11b of the cup 11 has a substantially prismatic or frustopyramidal shape with a square cross section, with a flat base 12. The maximum perimeter in the upper end of the lower region 11b is a square whose diagonal is clearly smaller than the minimum diameter of the lower end of the upper region 11a. As a result, the cup includes a transition region 11c connecting the upper and lower regions of the cup 11.

Although in FIGS. 9 to 12 the substantially prismatic or frustopyramidal shape of the lower region 11b of the cup 11 is shown with a square cross section, it will be understood that, alternatively, the substantially prismatic or frustopyramidal shape of the lower region 11b of the cup 11 might have a cross section with the shape of any other polygon with a number of sides equal or larger than three. Thus, with the utensil 3 according to the third embodiment shown in FIGS. 9 to 12, the shell-less egg white will adopt a prismatic or slightly frustopyramidal configuration with the substantially spherical yolk inside it.

Alternatively, the lower region 11b of the cup 11 of the container 10 might have many other shapes, including geometrical shapes, shapes imitating natural elements and fancy shapes for moulding shell-less boiled eggs or other liquid or doughy foods, all of them within the scope of the present invention.

Modifications, variations and combinations from the embodiments shown and described will occur to a person skilled in the art without departing from the scope of the present invention as it is defined in the attached claims.

1. A shell-less egg-boiling utensil comprising a container, sized to contain at least one shell-less egg, and a lid capable of closing said container containing said shell-less egg and closed by said lid can be immersed at least partially in boiling water in order to boil the egg, the container comprising a cup with a bottom, a top opening and a perimetric closing element arranged around said top opening, and the lid comprising a cover wall and a perimetric closing element that press fits into said perimetric closing element of the container, wherein said cup of the container has an upper region adjacent to the top opening that is bulkier than a lower region adjuacent to said bottom, so that the container, closed with the lid and containing said shell-less egg, will float in the boiling water with the cup being substantially submerged and the lid being substantially above water, characterised in that the container is made of a flexible material and has a perimetric flap extending outwards and downwards from a rim of said top opening, so that, when the utensil is floating, said perimetric flap will trap air, thereby contributing to the buoyancy and flotation stability of the utensil.

2. The shell-less egg-boiling utensil according to claim 1, wherein the lid is made of a flexible material and comprises a handle attached to said cover wall in such a position that said handle is substantially above the water when the utensil is floating in boiling water.

3. The shell-less egg-boiling utensil according to claim 2, wherein the perimetric closing element of the lid are configured so that, when press fitted together, they provide enough frictional force to lift the container containing said shell-less egg together with the lid when the utensil is grabbed by the handle.

4. The shell-less egg-boiling utensil according to claim 2, wherein the perimetric closing element of the container comprises an inner conical surface formed in said upper region of the cup and the perimetric closing element of the lid comprises an outer conical surface formed in a perimetric skirt extending downwards from the cover wall.

5. The shell-less egg-boiling utensil according to claim 2, wherein the cover wall of the lid has a shape of a dome with a concave depression in its top central area and the handle has the shape of a knob located in said concave depression.

6. The shell-less egg-boiling utensil according to claim 1, wherein the perimetric flap of the container has a convex shape so as to provide more room in a gap between the perimetric flap and the cup of the container.

7. The shell-less egg-boiling utensil according to claim 1, wherein said upper region of the cup of the container has a substantially frustoconical configuration and said lower region has a substantially hemispherical shape.

8. The shell-less egg-boiling utensil according to claim 1, wherein said upper region of the cup of the container has a substantially frustoconical configuration and said lower region has a substantially cylindrical or frustoconical shape of a smaller diameter, and a transition region connects the upper and lower regions of the cup.

9. The shell-less egg-boiling utensil according to claim 1, wherein said upper region of the cup of the container has a substantially frustoconical configuration and said lower region has a substantially prismatic or frustopyramidal shape, and a transition region connects the upper and lower regions of the cup.

10. The shell-less egg-boiling utensil according to claim 1, wherein said flexible material of which the container and the lid are made is platinum-catalyzed silicone.
